(19) United States
(12) Patent Application Publication
(10) Pub. No.: US 2020/0067104 A1
(43) Pub. Date: Feb. 27, 2020

(54) METHOD OF FORMING A CATALYST LAYER FOR A FUEL CELL

(71) Applicant: GM Global Technology Operations LLC, Detroit, MI (US)

(72) Inventors: Swaminatha P. Kumaraguru, Rochester Hills, MI (US); Mehul M. Vora, Rochester Hills, MI (US); Ellazar V. Niangar, Clarkston, MI (US)

(73) Assignee: GM Global Technology Operations LLC, Detroit, MI (US)

(21) Appl. No.: 16/112,063

(22) Filed: Aug. 24, 2018

(51) Int. Cl. H01M 4/86; H01M 4/88; H01M 8/1004; D04H 1/728

(52) U.S. Cl. CPC H01M 4/8626; H01M 4/8817; D04H 1/728; H01M 8/1004; H01M 4/8853

(57) ABSTRACT

A method of forming a catalyst layer for a fuel cell includes electrospinning a first solution of an ionomer, a binder, and a first solvent to form a porous mat having an interior and an exterior and including a plurality of ionomer nanofibers intertwined with one another to define a plurality of pores within the interior. A portion of the plurality of ionomer nanofibers define the exterior and have an internal surface facing the interior and an external surface facing away from the interior. The method also includes electrospraying a second solution of a catalyst and a second solvent onto the porous mat such that the catalyst is disposed on each external surface and is not embedded within the plurality of pores to thereby form the catalyst layer. A catalyst layer and a fuel cell are also described.

### INTRODUCTION

The disclosure relates to a method of forming a catalyst layer for a fuel cell.

A fuel cell is an electro-chemical device that generally includes an electrolyte disposed between two electrodes, e.g., an anode and a cathode. During operation of the fuel cell, hydrogen gas may enter the anode, and oxygen or air may enter the cathode. Hydrogen gas may dissociate in the anode to generate free hydrogen protons and electrons. Hydrogen protons may then pass through the electrolyte to the cathode, and react with oxygen and electrons in the cathode to generate water. Further, the electrons from the anode may not pass through the electrolyte but may instead be directed through a load to perform work. As such, several fuel cells may be combined to form a fuel cell stack to generate a desired fuel cell stack power output. For example, a fuel cell stack for a vehicle may include many stacked fuel cells.

Further, solid polymer fuel cells generally employ a membrane electrode assembly that may include a proton exchange membrane disposed between the electrodes. The membrane electrode assembly may also include a catalyst layer disposed at an interface between the proton exchange membrane and each electrode to thereby facilitate the electrochemical reaction described above.

### SUMMARY

A method of forming a catalyst layer for a fuel cell includes electrospinning a first solution of an ionomer, a binder, and a first solvent to form a porous mat. The porous mat has an interior and an exterior and includes a plurality of ionomer nanofibers intertwined with one another to define a plurality of pores within the interior. A portion of the plurality of ionomer nanofibers define the exterior and have an internal surface facing the interior and an external surface facing away from the interior. The method further includes electrospraying a second solution of a catalyst and a second solvent onto the porous mat such that the catalyst is disposed on each external surface and is not embedded within the plurality of pores to thereby form the catalyst layer.

Electrospraying may include not depositing the ionomer on the catalyst. Further, electrospraying may include minimizing an amount of ionomer in contact with the catalyst.

In one aspect, electrospinning may be concurrent to electrospraying. In another aspect, electrospinning may occur before electrospraying. In yet another aspect, the method may include alternatingly electrospinning and electrospraying.

The method may include reducing an overall oxygen transport resistance through the catalyst layer. The method may include reducing a local oxygen transport resistance at the catalyst. The method may include reducing a bulk oxygen transport resistance through the porous mat.

A catalyst layer for a fuel cell includes a porous mat having an exterior and an interior and including a plurality of ionomer nanofibers intertwined with one another to define a plurality of pores within the interior. A portion of the plurality of ionomer nanofibers define the exterior and have an internal surface facing the interior and an external surface facing away from the interior. The catalyst layer also includes a catalyst disposed on each external surface and not embedded within the plurality of pores.

In one aspect, the ionomer may not be disposed on the catalyst.

The catalyst may be disposed on each internal surface such that the catalyst is not unattached within the plurality of pores.

The porous mat may be formed from a first solution of an ionomer, a binder, and a first solvent. The catalyst may be formed from a second solution of the catalyst suspended in a second solvent.

In another aspect, the catalyst may include at least one catalyst aggregate.

A fuel cell includes two catalyst layers each including a porous mat having an interior and an exterior and including a plurality of ionomer nanofibers intertwined with one another to define a plurality of pores within the interior. A portion of the plurality of ionomer nanofibers define the exterior and have an internal surface facing the interior and an external surface facing away from the interior. The catalyst layer also includes a catalyst disposed on each external surface and not embedded within the plurality of pores. The fuel cell also includes a proton exchange membrane sandwiched between the two catalyst layers.

In one aspect, the catalyst may not be disposed within the interior of the porous mat.

In another aspect, the ionomer may not be disposed on the catalyst.

The porous mat may be formed from a first solution of an ionomer, a binder, and a first solvent. The catalyst may be formed from a second solution of the catalyst and a second solvent.

The above features and advantages and other features and advantages of the present disclosure will be readily apparent from the following detailed description of the preferred embodiments and best modes for carrying out the present disclosure when taken in connection with the accompanying drawings and appended claims.

### BRIEF DESCRIPTION OF THE DRAWINGS

FIG. 1 is a flowchart of a method of forming a catalyst layer for a fuel cell.

FIG. 2 is a schematic illustration of an exploded view of the fuel cell of FIG. 1 and a magnified view of the catalyst layer of FIG. 1.

FIG. 3 is a schematic illustration of a portion of the method of FIG. 1.

### DETAILED DESCRIPTION

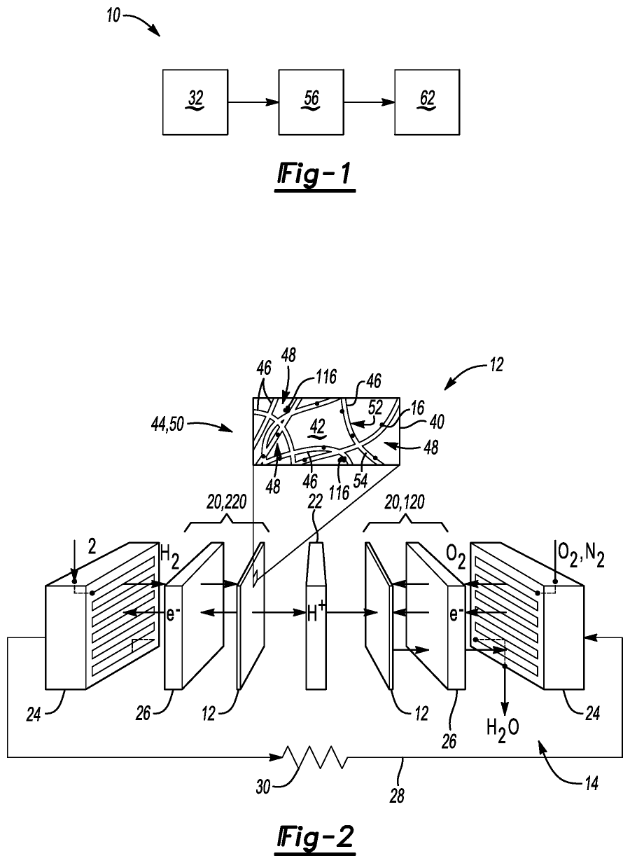

Referring to the Figures, wherein like reference numerals refer to like elements, a method 10 of forming a catalyst layer 12 (FIG. 2) for a fuel cell 14 is shown generally in FIG. 1. The method 10 may be useful for applications requiring fuel cells 14 that exhibit minimal voltage loss at high current densities, e.g., at current densities of greater than 1.5 A/cm² or greater than 2.0 A/cm². Further, the method 10 and resulting catalyst layer 12 may be useful for fuel cells 14 having reduced oxygen transport resistance and economical catalyst loading. In addition, as set forth in more detail below, the catalyst layer 12 does not include a catalyst 16 (FIG. 2) that is covered by or coated with an ionomer 18, and yet still provide ionomer conduction pathways through the catalyst layer 12. As such, the method 10 may be economical in terms of time and cost, may be scalable to mass production manufacturing operations, and may eliminate manufacturing steps such as bar-coating and knife-coating.

Therefore, the method 10, catalyst layer 12, and fuel cell 14 may be useful for vehicular applications such as, but not limited to, automobiles, buses, forklifts, motorcycles, bicycles, trains, trams, spacecraft, airplanes, farming equipment, boats, and submarines. Alternatively, the method 10, catalyst layer 12, and fuel cell 14 may be useful for non-vehicular applications such as stationary power generation, portable power generation, electronics, remote weather stations, communications centers, research stations, and the like. More specifically, by way of a non-limiting example, the method 10, catalyst layer 12, and fuel cell 14 may be useful for polymer electrolyte membrane fuel cell applications for non-autonomous, autonomous, or semi-autonomous vehicle applications.

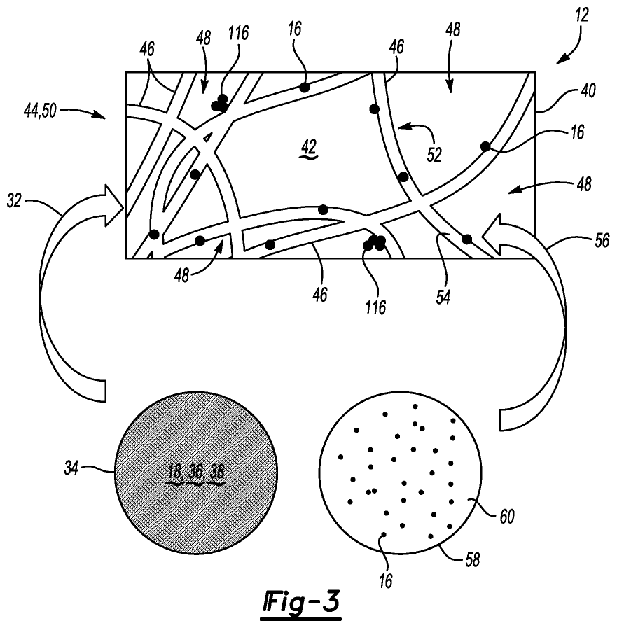

Referring to the Figures, wherein like reference numerals refer to like elements, the fuel cell 14 including the catalyst layer 12 is shown generally in FIG. 2. Further, the method 10 of forming the catalyst layer 12 is shown generally in FIGS. 1 and 3.

More specifically, as described with reference to FIG. 2, the fuel cell 14 includes an electrode 20, e.g., a cathode 120 and/or an anode 220, and a proton exchange membrane 22, e.g., an electrolyte or a polymer electrolyte membrane. In particular, the proton exchange membrane 22 may be sandwiched between two catalyst layers 12. That is, as shown in greater detail in FIG. 2, the fuel cell 14 may be formed from one or more membrane electrode assemblies (MEA) that include the cathode 120, anode 220, proton exchange membrane 22; a plurality of flow plates 24; one or more catalyst layers 12; and a plurality of gas diffusion layers 26.

During operation of the fuel cell 14, chemical energy from an electrochemical reaction of hydrogen (H²) and oxygen (O₂) may transform to electrical energy. In particular, as described with reference to FIG. 2, hydrogen gas (H₂) may enter the anode 220 and catalytically split into protons (H⁺) and electrons (e) at the catalyst layer 12 of the anode 220. The protons (H⁺) may permeate through the proton exchange membrane 22 to the cathode 120, but the electrons (e⁻) may not permeate through the proton exchange membrane 22. Instead, the electrons (e₋) may travel along an external load circuit 28 to the cathode 120 to produce a fuel cell stack power output 30 or electrical current. Concurrently, air, e.g., oxygen (O₂), may enter the cathode 120, react with the protons (H⁺) permeating through the proton exchange membrane 22 and the electrons (e⁻) arriving to the cathode 120 from the external load circuit 28, and form a byproduct, i.e., water (H₂O) and heat, which may be expelled from the fuel cell 14.

Stated differently, for fuel cells 14 employing hydrogen as a fuel and oxygen-containing air (or substantially pure oxygen) as an oxidant, the above-described catalyzed reaction at the anode 220 may produce hydrogen cations (protons) from the fuel. The proton exchange membrane 22 may facilitate a migration of the protons from the anode 220 to the cathode 120. In addition to conducting protons, the proton exchange membrane 22 may isolate the hydrogen-containing fuel from the oxygen-containing oxidant. At the catalyst layer 12 of the cathode 120, oxygen may react with the protons that have crossed the proton exchange membrane 22 to form water. The reactions at the anode 220 and cathode 120 are set forth in the following equations:

Anode 220 reaction: H₂→2H⁺+2e⁻

Cathode 120 reaction: ½O₂+2H⁺+2e⁻→H₂O

The MEA may be disposed between two electrically conductive fluid flow plates 24 or separator plates. Each fluid flow plate 24 may have at least one flow passage formed in at least one major planar surface. The at least one flow passage may direct the fuel and oxidant to or across the respective electrodes 20, namely, the anode 220 on a fuel side of the MEA and the cathode 120 on an oxidant side of the MEA. The fluid flow plates 24 may act as current collectors, provide support for the electrodes 20, provide access channels for the fuel and oxidant to respective surfaces of the anode 220 and cathode 120, and provide channels for removal of reaction products, such as water, formed during operation of the fuel cell 14.

Referring now to FIGS. 1 and 3, the method 10 of forming the catalyst layer 12 includes electrospinning 32 a first solution 34 of an ionomer 18, a binder 36, and a first solvent 38 to form a porous mat 40. As used herein, the terminology electrospinning 32 refers to a fiber production process that uses an electric force to draw charged threads of polymer to form the porous mat 40. That is, electrospinning 32 refers to a process in which ultrathin, multifilament fibers having diameters in the nanometer to micrometer range may be created from a Taylor cone by spinning and manipulating streams of electrically-charged polymer in a strong magnetic or electric field to form the porous mat 40. As a result of electrospinning 32, the porous mat 40 may be a fibrous scaffold.

More specifically, as described with reference to FIGS. 2 and 3, the porous mat 40 has an interior 42, i.e., an inside, and an exterior 44, i.e., an outside, and includes a plurality of ionomer nanofibers 46 intertwined with one another to define a plurality of pores 48 within the interior 42. That is, electrospinning 32 the first solution 34 forms the porous mat 40 that may include a network of ionomer nanofibers 46 and exhibit intra- and inter-ionomer nanofiber porosity. The porosity of the porous mat 40 may enable efficient oxygen transport, i.e., may reduce a resistance to oxygen transport, through the catalyst layer 12. However, the intertwined ionomer nanofibers 46 may still provide efficient proton (H⁺) conduction through the catalyst layer 12.

Further, a portion 50 of the plurality of ionomer nanofibers 46 define the exterior 44 and have an internal surface 52 facing the interior 42 and an external surface 54 facing away from the interior 42. That is, each of the ionomer nanofibers 46 at the outside or exterior 44 of the porous mat 40 has the front or external surface 54 and the back or internal surface 52. The back or internal surface 52 faces the interior 42 and/or one or more adjacent ones of the plurality of ionomer nanofibers 46. In contrast, each of the plurality of ionomer nanofibers 46 defining the exterior 44 has the external surface 54 that faces away from one or more adjacent ones of the plurality of ionomer nanofibers 46.

Referring now to FIG. 3, the porous mat 40 is formed from the first solution 34, and the first solution 34 includes the ionomer 18, the binder 36, and the first solvent 38. A suitable example of the ionomer 18 may include, but is not limited to, a perfluorosulfonic acid ionomer. Suitable examples of the binder 36 may include, but are not limited to, polyvinylpyrrolidone, polyacrylic acid, and combinations thereof. Further, suitable examples of the first solvent 38 may include, but are not limited to, n-propanol, water, and combinations thereof, e.g., nPrOH:H₂O::3:1 w/w. Importantly, the first solution 34 does not include the catalyst 16, as set forth in more detail below.

Referring again to FIGS. 1 and 3, the method 10 also includes electrospraying 56 a second solution 58 of the catalyst 16 and a second solvent 60 onto the porous mat 40 such that the catalyst 16 is disposed on each external surface 54 and is not embedded within the plurality of pores 48 to thereby form the catalyst layer 12. That is, electrospraying 56 disposes the catalyst 16 on the external surface 54 such that the catalyst 16 is not caught within the interior 42 of the porous mat 40. In other words, the catalyst 16 may not be embedded without attachment in the plurality of pores 48.

In some instances, the catalyst 16 may be disposed on each internal surface 52. However, the catalyst 16 may be disposed on each internal surface 52 such that the catalyst 16 is not unattached within the plurality of pores 48. That is, the catalyst 16 may not be suspended or free-floating or otherwise embedded within the plurality of pores 48 without attachment to at least one of the plurality of plurality of ionomer nanofibers 46. Therefore, the catalyst 16 may not be disposed within the interior 42 of the porous mat 40. Stated differently, electrospraying 56 may include not depositing the ionomer 18 onto the catalyst 16 and not mixing the ionomer 18 with the catalyst 16. As such, the ionomer 18 may not be disposed on, e.g., may not cover or coat, the catalyst 16. Therefore, electrospraying 56 may also include minimizing an amount of ionomer 18 in contact with the catalyst 16.

As used herein, the terminology electrospraying 56 refers to a process in which a comparatively high voltage is applied to the second solution 58 to form an aerosol that may be directed onto the porous mat 40, e.g., onto the external surface 54 of the portion 50 of the plurality of ionomer nanofibers 46 that define the exterior 44 of the porous mat 40. In particular, although not shown, the comparatively high voltage may be applied to the second solution 58 supplied through an emitter having a tip. As the second solution 58 reaches the tip, the second solution 58 may form a Taylor cone having an apex, and the second solution 58 may emit from the apex as an aerosol.

Referring now to FIG. 3, the catalyst 16 is formed from the second solution 58 of the catalyst 16 and the second solvent 60, e.g., the catalyst 16 suspended in the second solvent 60. Suitable examples of the catalyst 16 may include, but are not limited to, platinum, cobalt, nickel, and alloys and combinations thereof. Further, as shown in FIG. 3, the catalyst 16 may also include at least one catalyst aggregate 116, e.g., a cluster or agglomeration of the catalyst 16. The second solvent 60 may be n-propanol in water, e.g., nPrOH:H₂O::3:1 w/w. Importantly, the second solution 58 includes the catalyst 16 and is separate from, i.e., not mixed with, the first solution 34 for the method 10.

In one embodiment, electrospinning 32 may be concurrent to electrospraying 56. That is, the method 10 may include simultaneously electrospinning 32 the first solution 34 and electrospraying 56 the second solution 58. For instance, the second solution 58 including the catalyst 16 may be electrosprayed during ionomer nanofiber 46 production to form the catalyst layer 12.

In another embodiment, electrospinning 32 may occur before electrospraying 56. For example, the method 10 may include alternatingly electrospinning 32 and electrospraying 56. That is, the method 10 may include forming some of the porous mat 40 before depositing the catalyst 16 onto the external surface 54 of the plurality of ionomer nanofibers 46.

The method 10 may further include reducing 62 an overall oxygen transport resistance through the catalyst layer 12. That is, without the presence of the catalyst 16 disposed on the external surface 54 and not embedded within the plurality of pores 48, voltage loss may otherwise be observed during operation of the fuel cell 14 at high current densities, e.g., greater than 1.5 A/cm² or greater than 2.0 A/cm². However, since the catalyst layer 12 includes the catalyst 16 disposed on the external surface 54 instead of embedded within the plurality of pores 48 without attachment, the catalyst layer 12 may minimize the overall resistance to oxygen transport through the catalyst layer 12 and therefore minimize voltage loss.

More specifically, the overall oxygen transport resistance may be attributed to a local oxygen transport resistance, e.g., resistance local to the catalyst 16, and a bulk oxygen transport resistance, e.g., resistance through the porous mat 40. The method 10 may further include reducing 62 the local oxygen transport resistance at the catalyst 16. That is, since the ionomer 18 may not coat or cover the catalyst 16 and may therefore not form a patchy or non-uniform coating on a surface of the catalyst 16, there may be minimal resistance to local oxygen transport at the catalyst 16. Stated differently, the method 10 may avoid directly covering the catalyst 16 with the ionomer 18 and the method 10 may therefore include minimizing the local oxygen transport resistance at the catalyst 16. As such, the catalyst layer 12 may enable fuel cells 14 that are operable at comparatively higher voltages and current densities.

Additionally or alternatively, the method 10 may further include reducing 62 the bulk oxygen transport resistance through the porous mat 40. That is, since the method 10 includes electrospinning 32 the first solution 34 to form the porous mat 40 having the plurality of pores 48, oxygen may freely travel through the porous mat 40. Further, the porous mat 40 may enable efficient proton (W) conduction to the catalyst 16 and the method 10 may include minimizing the bulk oxygen transport resistance through the porous mat 40.

Therefore, the method 10 is economical, reproducible, and cost-effective and may consolidate or eliminate additional manufacturing processes to form the catalyst layer 12. The method 10 may be useful for applications requiring fuel cells 14 that exhibit minimal voltage loss at high current densities, e.g., at current densities of greater than 1.5 A/cm² or greater than 2.0 A/cm². Further, the method 10 and resulting catalyst layer 12 may be useful for fuel cells 14 having reduced oxygen transport resistance, high voltage operation at high current densities, and economical catalyst loading. In addition, the method 10 and catalyst layer 12 may avoid catalyst 16 that is covered by or coated with the ionomer 18, and yet may still provide ionomer conduction pathways through the catalyst layer 12. As such, the method 10 may be economical in terms of time and cost, may be scalable to mass production manufacturing operations, and may eliminate manufacturing steps such as bar-coating and knife-coating.

While the best modes for carrying out the disclosure have been described in detail, those familiar with the art to which this disclosure relates will recognize various alternative designs and embodiments for practicing the disclosure within the scope of the appended claims.

What is claimed is:

1. A method of forming a catalyst layer for a fuel cell, the method comprising:
electrospinning a first solution of an ionomer, a binder, and a first solvent to form a porous mat having an interior and an exterior and including a plurality of ionomer nanofibers intertwined with one another to define a plurality of pores within the interior;
wherein a portion of the plurality of ionomer nanofibers define the exterior and have an internal surface facing the interior and an external surface facing away from the interior; and
electrospraying a second solution of a catalyst and a second solvent onto the porous mat such that the catalyst is disposed on each external surface and is not embedded within the plurality of pores to thereby form the catalyst layer.

2. The method of claim 1, wherein electrospraying includes not depositing the ionomer onto the catalyst.

3. The method of claim 1, wherein electrospraying includes minimizing an amount of ionomer in contact with the catalyst.

4. The method of claim 1, wherein electrospinning is concurrent to electrospraying.

5. The method of claim 1, wherein electrospinning occurs before electrospraying.

6. The method of claim 5, wherein the method includes alternatingly electrospinning and electrospraying.

7. The method of claim 1, further including reducing an overall oxygen transport resistance through the catalyst layer.

8. The method of claim 1, further including reducing a local oxygen transport resistance at the catalyst.

9. The method of claim 1, further including reducing a bulk oxygen transport resistance through the porous mat.

10. A catalyst layer for a fuel cell, the catalyst layer comprising:
a porous mat having an exterior and an interior and including a plurality of ionomer nanofibers intertwined with one another to define a plurality of pores within the interior;
wherein a portion of the plurality of ionomer nanofibers define the exterior and have an internal surface facing the interior and an external surface facing away from the interior; and
a catalyst disposed on each external surface and not embedded within the plurality of pores.

11. The catalyst layer of claim 10, wherein the ionomer is not disposed on the catalyst.

12. The catalyst layer of claim 10, wherein the catalyst is disposed on each internal surface such that the catalyst is not unattached within the plurality of pores.

13. The catalyst layer of claim 10, wherein the porous mat is formed from a first solution of an ionomer, a binder, and a first solvent.

14. The catalyst layer of claim 10, wherein the catalyst is formed from a second solution of the catalyst suspended in a second solvent.

15. The catalyst layer of claim 10, wherein the catalyst includes at least one catalyst aggregate.

16. A fuel cell comprising:
two catalyst layers each including:
a porous mat having an interior and an exterior and including a plurality of ionomer nanofibers intertwined with one another to define a plurality of pores within the interior;
wherein a portion of the plurality of ionomer nanofibers define the exterior and have an internal surface facing the interior and an external surface facing away from the interior; and
a catalyst disposed on each external surface and not embedded within the plurality of pores; and
a proton exchange membrane sandwiched between the two catalyst layers.

17. The fuel cell of claim 16, wherein the catalyst is not disposed within the interior of the porous mat.

18. The fuel cell of claim 16, wherein the ionomer is not disposed on the catalyst.

19. The fuel cell of claim 16, wherein the porous mat is formed from a first solution of an ionomer, a binder, and a first solvent.

20. The fuel cell of claim 16, wherein the catalyst is formed from a second solution of the catalyst and a second solvent.
